(19) United States
(12) Patent Application Publication
(10) Pub. No.: US 2020/0361546 A1
(43) Pub. Date: Nov. 19, 2020

(54) TORSION AXLE PIN BOX

(71) Applicant: Lippert Components, Inc., Elkhart, IN (US)

(72) Inventors: Jeffrey Few, Elkhart, IN (US); Vishwatej Mane, South Bend, IN (US); Evan Whitney, Edwardsburg, MI (US)

(21) Appl. No.: 16/872,476

(22) Filed: May 12, 2020

Related U.S. Application Data
(60) Provisional application No. 62/847,656, filed on May 14, 2019.

(51) Int. Cl. B62D 53/08

(52) U.S. Cl. CPC B62D 53/0885

(57) ABSTRACT

A fifth wheel pin box includes a torsion axle having an outer tube connected to a towed vehicle mounting bracket and an inner bar connected by pivot arms to a coupler plate bearing a coupler pin. The pin box may be connected between a towed vehicle and a tow vehicle in an orientation in which both chucking loads and bounce loads cause the inner bar to rotate with respect to the outer tube. Resilient, compressible members disposed between the inner bar and outer tube absorb the loads.

### CROSS-REFERENCES TO RELATED APPLICATIONS

This application claims the benefit of U.S. Provisional Patent Application No. 62/847,656, filed May 14, 2019, the entire content of which is herein incorporated by reference.

### STATEMENT REGARDING FEDERALLY SPONSORED RESEARCH OR DEVELOPMENT

(NOT APPLICABLE)

### BACKGROUND

The invention relates to a fifth wheel pin box and, more particularly, to a torsion axle pin box that absorbs both bounce loads and chucking loads.

A fifth wheel pin box is a structure attached to the frame of a towed vehicle that is selectively connectable to a hitch located on a tow vehicle. Some pin boxes are rigid structures that transfer load between the towed vehicle and the tow vehicle without any shock absorption, damping or vibration isolation. Other pin boxes may include means for shock absorption, damping, and/or vibration isolation. Typically, such shock absorption and/or damping means absorb and/or dampen shock, vibration, and relative movement occurring between the pin box and hitch in a horizontal direction (sometimes referred to as “chucking”), as may result from the tow vehicle accelerating or decelerating, or in a vertical direction (sometimes referred to as “bounce”), as may result from the towed and/or tow vehicle encountering road surface irregularities. Some pin boxes include structure for absorbing and/or damping chucking and separate structure for absorbing and/or damping bounce.

### SUMMARY

A fifth wheel pin box includes a torsion axle having an outer tube connected to a towed vehicle mounting bracket and an inner bar connected by pivot arms to a coupler plate bearing a coupler pin. The pin box may be connected between a towed vehicle and a tow vehicle in an orientation in which both chucking loads and bounce loads cause the inner bar to rotate with respect to the outer tube. Resilient, compressible members disposed between the inner bar and outer tube absorb the loads.

In an exemplary embodiment, a fifth wheel pin box includes an elongated torsion axle having an elongated outer tube, an elongated inner bar with a longitudinal axis disposed within the outer tube, and a plurality of resilient, compressible members disposed between the inner bar and the outer tube. The plurality of resilient, compressible members serve to bias the inner bar to a first orientation with respect to the outer tube. The fifth wheel pin box also includes a towed vehicle mounting bracket connected to the outer tube, a plurality of pivot arms having respective first ends connected to the elongated inner bar in keyed engagement therewith, a coupler plate connected to respective second ends of the plurality of pivot arms, and a coupler pin extending from the coupler plate. The coupler pin has a longitudinal axis and is configured for selective engagement with a fifth wheel hitch. Rotation of the elongated inner bar about the inner bar longitudinal axis in either of a first direction and a second direction from the first orientation compresses or further compresses the plurality of resilient, compressible members.

Rotation of the elongated inner bar about the inner bar longitudinal axis in either of a first direction and a second direction from the first orientation may result in displacement of the pin through an arc, where the arc is tangent to the pin longitudinal axis. Ones of the plurality of the resilient, compressible members may have a first hardness and others of the resilient, compressible members may have a second hardness greater than the first hardness. The pin box may include a damper connected between the coupler plate and at least one of the towed vehicle mounting bracket and the torsion axle. The torsion axle may also include a first end plate connected to the outer tube proximate a first end thereof and a second end plate connected to the outer tube proximate a second end thereof.

In another exemplary embodiment, a torsion axle pin box includes a torsion axle assembly having an outer tube, an inner bar, and a compressible member disposed between the outer tube and the inner bar, a towed vehicle mounting bracket connected to the outer tube, and first and second pivot arms connected to the inner bar. A coupler plate is connected between the first and second pivot arms, and a coupler pin is connected to the coupler plate. The outer tube and the towed vehicle mounting bracket are pivotable relative to the inner bar and the first and second pivot arms.

A cross-section of the outer tube may be non-circular. The torsion axle pin box may also include first and second end plates connected at respective ends of the outer tube. The first and second end plates may be provided with openings therein shaped corresponding to the cross-section of the outer tube, where the first and second end plates are secured to the towed vehicle mounting bracket.

The outer tube may be an elongated square tube with four side walls, and the inner bar may be an elongated square bar. In this context, corners of the inner bar may be positioned at about a midpoint of respective ones of each of the four side walls, thereby defining four essentially triangular voids, where a plurality of compressible members may be disposed in the triangular voids. In some embodiments, at least one of the compressible members has a first hardness, and at least another of the compressible members has a second hardness, different from the first hardness.

The torsion axle pin box may include an intermediate tube disposed between the outer tube and the inner bar. In this context, the outer tube may be an elongated square tube with four side walls, the intermediate tube may be an elongated square tube with four side walls, and the inner bar may be an elongated square bar. Corners of the intermediate tube may be positioned at about a midpoint of respective ones of each of the four side walls of the outer tube, thereby defining a first four essentially triangular voids, and corners of the inner bar may be positioned at about a midpoint of respective ones of each of the four side walls of the intermediate tube, thereby defining a second four essential triangular voids. A plurality of compressible members may be disposed in the first and second triangular voids.

The first and second pivot arms may be connected to opposite ends of the inner bar in keyed engagement. A longitudinal axis of the torsion axle assembly may be perpendicular to and spaced from a longitudinal axis of the coupler pin, and a line through the torsion axle axis and the coupler pin may be angled greater than 10 degrees relative to ground. In some embodiments, the line through the torsion axle axis and the coupler pin may be angled between 20-70 degrees.

The compressible member may be in the form of a single monolithic block of resilient compressible material filling a space between the outer tube and the inner bar.

The torsion axle pin box may also include first and second end plates connected at respective ends of the outer tube, and a spring assembly connected between each of the first and second end plates and the first and second pivot arms, respectively.

The torsion axle pin box may include a plurality of support tubes or gusset plates interconnecting the first and second pivot arms.

The inner bar may be a cross-shaped profile defining four voids between the inner bar and the outer tube. In this context, at least one of the compressible member may be disposed within each of the four voids.

### BRIEF DESCRIPTION OF THE DRAWINGS

These and other aspects and advantages will be described in detail with reference to the accompanying drawings, in which:

FIG. 1 is a perspective view of a torsion axle pin box according to the present disclosure;

FIG. 2 is a front elevation view of the torsion axle pin box of FIG. 1;

FIG. 3 is top plan view of the torsion axle pin box of FIG. 1;

FIG. 4 is a side elevation view of the torsion axle pin box of FIG. 1;

FIG. 5 is a cross-sectional side elevation view of the torsion axle pin box of FIG. 1;

FIG. 6 is an end view of a torsion axle of the torsion axle pin box of FIG. 1;

FIG. 6A is an end view of an alternative torsion axle of the torsion axle pin box of FIG. 1;

FIG. 7A is a perspective view showing the torsion axle pin box of FIG. 1 connected to a tow vehicle and a towed vehicle;

FIG. 7B is a partial cut-away side elevation view showing the torsion axle pin box of FIG. 1 connected to a tow vehicle and a towed vehicle;

FIG. 8 is a perspective view of another torsion axle pin box according to the present disclosure;

FIG. 9 is a front elevation view of the torsion axle pin box of FIG. 8;

FIG. 10 is top plan view of the torsion axle pin box of FIG. 8;

FIG. 11 is a side elevation view of the torsion axle pin box of FIG. 8;

FIG. 12 is an exploded perspective view of the torsion axle pin box of FIG. 8;

FIG. 13 is a partial perspective view of the torsion axle pin box of FIG. 8;

FIG. 14 is a side cross sectional view of the torsion axle pin box of FIG. 8;

FIG. 15 is an exploded perspective view of a variation of the torsion axle pin box of FIG. 8;

FIG. 15A is a perspective view of a further variation of the torsion axle pin box of FIG. 9;

FIG. 16 is a perspective view of a further torsion axle pin box according to the present disclosure;

FIG. 17 is a front elevation view of the torsion axle pin box of FIG. 16;

FIG. 18 is a top plan view of the torsion axle pin box of FIG. 16;

FIG. 19 is a side elevation view of the torsion axle pin box of FIG. 16;

FIG. 20 is a side cross-sectional view of the torsion axle pin box of FIG. 16;

FIG. 21 is a perspective view of yet another torsion axle pin box according to the present disclosure; and

FIG. 22 is a perspective view of a portion of the torsion axle pin box of FIG. 21.

### DETAILED DESCRIPTION

The drawings show illustrative embodiments of a torsion axle pin box according to the present disclosure.

### First Embodiment

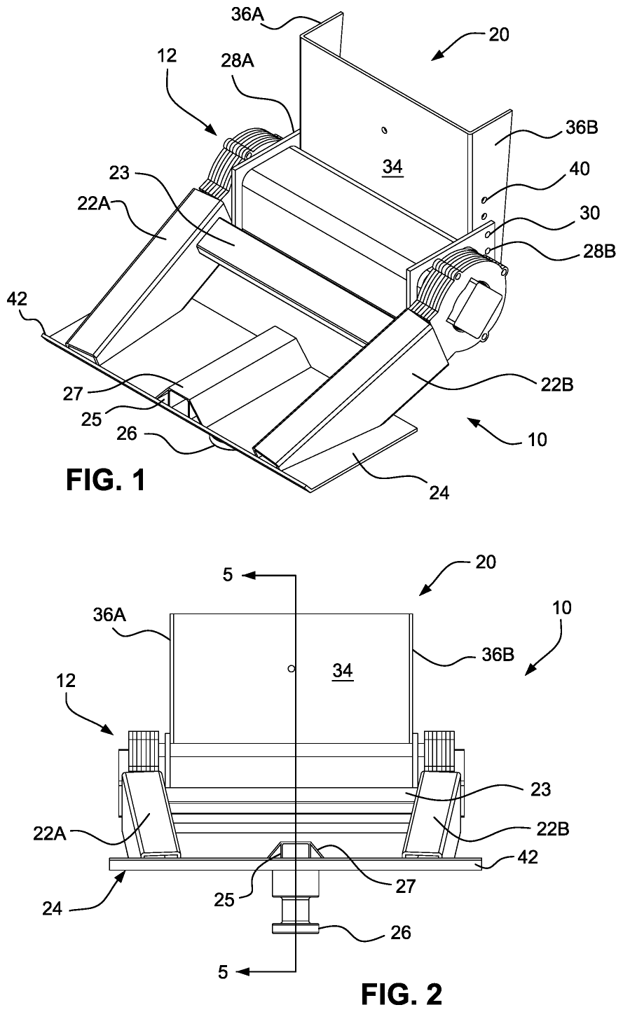

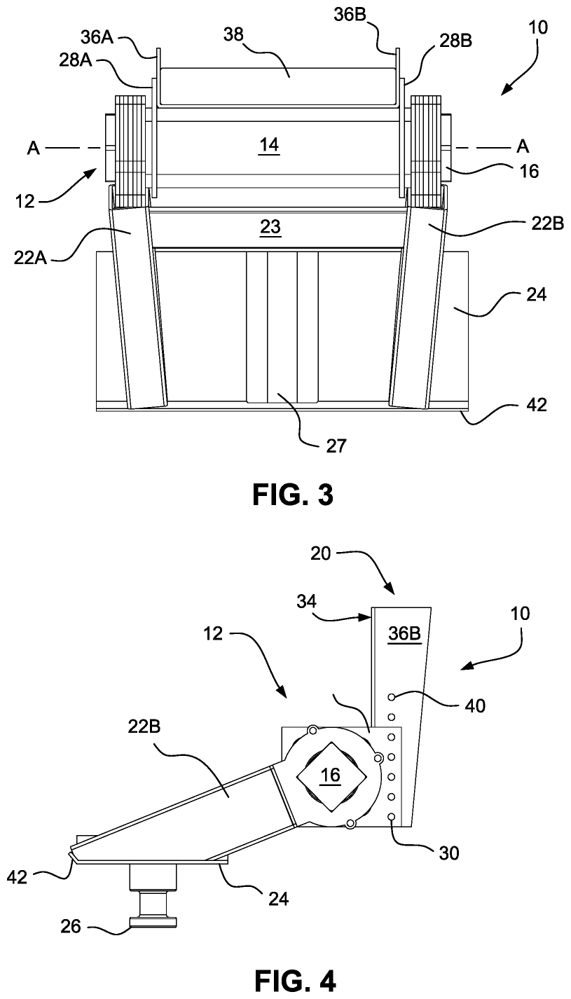

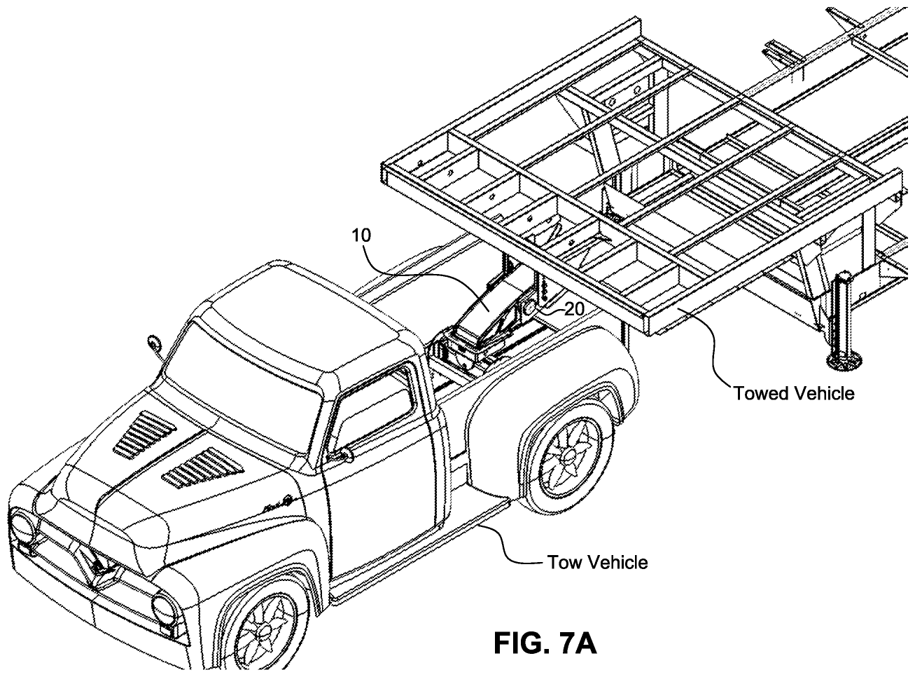

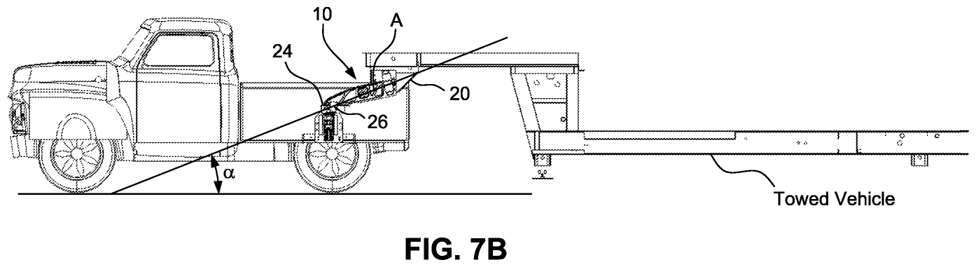

In an embodiment, as shown in FIGS. 1-8, a torsion axle pin box 10 includes a torsion axle assembly 12 having an outer tube 14 and an inner bar 16 and a plurality of compressible members 18 therebetween. The torsion axle pin box 10 also includes a towed vehicle mounting bracket 20 connected to the outer tube, first and second pivot arms 22A, 22B connected to the inner bar 16, a coupler plate 24 connected to the first and second pivot arms 22A, 22B, and a coupler pin 26 connected to the coupler plate 24. FIGS. 7A and 7B show the torsion axle pin box 10 connected to a tow vehicle and a towed vehicle. FIG. 7A best shows the coupler pin 26 connected to the tow vehicle and the towed vehicle mounting bracket 20 connected to the towed vehicle.

The outer tube 14 of the torsion axle assembly 12 is shown as an elongated, square tube having four side walls, a first end, and a second end. Each of the four side walls has an inner surface and an outer surface. In an embodiment, a first end plate 28A is attached to the outer tube 14 at or near its first end, for example, by welding. A second end plate 28B is similarly attached to the outer tube 14 at or near its second end. Each of the first and second end plates 28A, 28B defines an opening configured to receive the respective end of the outer tube 14 so that the end plates may be welded to the outer surface of any or all of the walls of the outer tube 14. As shown, each of the end plates 28A, 28B may be located inboard of the respective end of the outer tube 14. Each of the first and second end plates 28A, 28B may define a plurality of holes 30 configured to receive mechanical fasteners (not shown) that may be used to connect the end plates 28A, 28B to the towed vehicle mounting bracket 20, as will be discussed further below. In another embodiment, either or both of the first and second end plates 28A, 28B could be omitted, and the towed vehicle mounting bracket 20 could be connected directly to the outer tube 14.

The inner bar 16 is shown as an elongated square bar received within the outer tube 14, the inner bar having a first end extending outwardly beyond the first end of the outer tube 14, a second end extending outwardly beyond the second end of the outer tube 14, and four side surfaces cooperating with each other to define four corners. As shown, each of the four corners of the inner bar 16 is oriented at about the midpoint of a corresponding one of the four side walls of the outer tube 14. The inner bar 16 and the outer tube 14 thereby cooperate to define four generally triangular voids 32 between the walls of the outer tube 14 and the side surfaces of the inner bar 16.

As set forth above, a plurality of resilient, compressible members 18 are disposed between the outer tube 14 and the inner bar 16. More specifically, at least one compressible member 18 is disposed within each of the plurality of voids 32. In an embodiment, any or all of the compressible members 18 may be elongated, and any or all of the compressible members 18 may extend the length of the outer tube 14 or less than the length of the outer tube. In an embodiment, two or more of the compressible members 18, each shorter than the outer tube 14, may be disposed in any or all of the voids 32. For example, a first compressible member 18 may be disposed in one of the voids 32 proximate the first end of the outer tube, and a second compressible member 18 may be disposed in the same one of the voids proximate the second end of the outer tube 14.

The compressible members 18 may be provided with cylindrical cross-sections or cross-sections of other shapes. In the embodiment shown, the compressible members 18 are provided with cylindrical cross-sections. The compressible members 18 generally conform to the shape of the voids 32 in which they are inserted. The outer tube 14, the inner bar 16, and the compressible members 18 are configured so that the compressible members bias the inner bar to a predetermined orientation with respect to the outer tube 14 in the absence of a torque applied to either of the outer tube 14 and the inner bar 16 with respect to the other of the outer tube and the inner bar.

One or ones of the compressible members 18 may have a first hardness (sometimes referred to as “durometer”), and another one or other ones of the compressible members 18 may have a second hardness, the second hardness being greater than the first hardness. The compressible members 18 may be made of any suitable material, for example, nitrile rubber or buna-n rubber, having any suitable durometer, for example, a Shore A, B, C, or D durometer of about 60-120.

Each of the outer tube 14 and the inner bar 16 has a longitudinal axis. The longitudinal axes of the outer tube 14 and the inner bar 16 may be coincident or nearly coincident when the inner bar 16 and the compressible members 18 are received within the outer tube 14 as described above. The foregoing coincident or nearly coincident longitudinal axes of the outer tube 14 and the inner bar 16 may be referred herein as the longitudinal axis A of the torsion axle assembly 12.

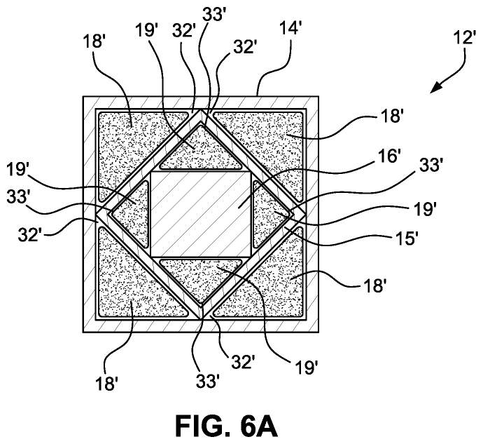

FIG. 6A shows an alternative torsion axle assembly 12′ having an outer tube 14′ similar to the outer tube 14, an inner bar 16′ similar to the inner bar 16, and an intermediate tube 15′ disposed within the outer tube 14′ and surrounding the inner bar 16′. The outer tube 14′ and the intermediate tube 15′ cooperate to define first voids 32′ similar to the voids 32. First compressible members 18′ similar to the compressible members 18 are disposed in the first voids 32′. The intermediate tube 15′ and the inner bar 16′ cooperate to define second voids 33′ similar to the first voids 32′. Second compressible members 19′ are disposed in the second voids 33′. In an embodiment, the second compressible members 19′ may be similar to the first compressible members 18′. In another embodiment, the second compressible members 19′ may be of substantially different durometer than the first compressible members 19′. In such an embodiment, the first compressible members 18′ may provide a first level or stage of damping, and the second compressible members 19′ may provide a second level or stage of damping, based on the different durometers of the first and second compressible members and/or the relative geometries of the respective voids 32′, 33′ and the structures defining them.

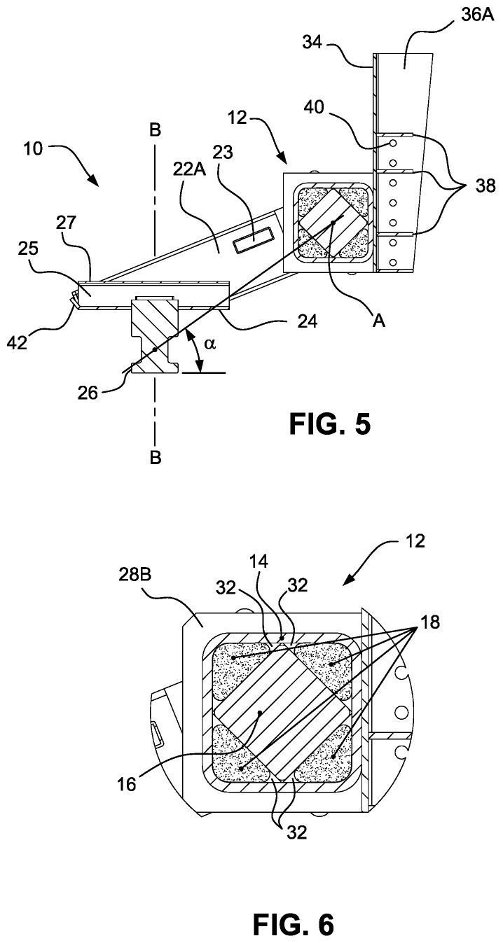

With reference to FIGS. 1, 2, 4 and 5, the towed vehicle mounting bracket 20 is shown including a web 34 having first and second sides, a first flange 36A connected to and extending perpendicularly from the first side of the web 34, a second flange 36B connected to and extending perpendicularly from the second side of the web 34 (and parallel to the first flange 36A) and a plurality of stiffening webs 38 (FIG. 5) extending perpendicularly from and connected to the web 34, the first flange 36A, and the second flange 36B. Each of the first and second flanges 36A, 36B defines a plurality of mounting holes 40 configured to receive mechanical fasteners that may be used to connect the towed vehicle mounting bracket 20 to the respective end plates 28A, 28B of the outer tube 14. The respective pluralities of holes 30, 40 in the first and second end plates 28A, 28B and the first and second flanges 36A, 36B may be configured to allow the towed vehicle mounting bracket 20 to be connected to the end plates 28A, 28B in a number of different relative positions.

Alternatively, the towed vehicle mounting bracket 20 may be welded to the outer surface of a wall of the outer tube 14. In such an embodiment, the towed vehicle mounting bracket 20 may take another form, and the mounting holes 40 in the flanges 36A, 36B thereof could be omitted.

The towed vehicle mounting bracket 20 may further define another plurality of mounting holes (not shown) configured to receive mechanical fasteners that may be used to connect the towed vehicle mounting bracket to a towed vehicle, for example, to the frame of a towed vehicle. Alternatively, the towed vehicle mounting bracket 20 may be welded or otherwise attached to the towed vehicle.

A first end of the first pivot arm 22A is connected in fixed engagement to the first end of the inner bar 16. Similarly, a first end of the second pivot arm 22B is connected in fixed engagement to the second end of the inner bar 16. As shown, the first end of each of the first pivot arm 22A and the second pivot arm 22B defines an aperture configured to receive the respective end of the inner bar 16 in keyed engagement.

Respective second ends of the first and second pivot arms 22A, 22B are connected to the coupler plate 24. The coupler plate 24 extends between, and may extend beyond, the first and second pivot arms 22A, 22B. As shown, the coupler plate 24 is generally planar and rectangular. A leading edge 42 of the coupler plate 24 may be upturned to facilitate engagement of the pin box 10 with a fifth wheel hitch (not shown) of a tow vehicle (not shown), as will be discussed further below. As shown, each the first and second pivot arms 22A, 22B may angle inwardly toward the other of the first and second pivot arms 22A, 22B as the first and second pivot arms traverse the coupler plate 24.

The coupler pin 26 is connected to the coupler plate 24 in fixed engagement. The coupler pin 26 may be welded to the underside of the coupler plate 24. As shown, the coupler pin 26 may include a shank extending through a corresponding opening in the coupler plate 24. In such an embodiment, the coupler pin 26 may be welded to either or both of the underside and the upper side of the coupler plate 24.

A stiffener 27 may be connected to the upper side of the coupler plate 24, for example, between the first pivot arm 22A and the second pivot arm 22B. As shown, the stiffener 27 may include a first member in the form of a U-shaped channel and a second member in the form of a splayed, U-shaped channel overlying the first member. The stiffener 27 may be connected to the coupler plate 24, for example, by welding.

The coupler pin 26 defines a longitudinal axis B (FIG. 5). The coupler pin longitudinal axis B is perpendicular to and spaced apart from the torsion axle axis A, so that the torsion axle axis A does not intersect the coupler pin axis B.

Rotation of the elongated inner bar 16 with respect to the outer tube 14 in either of a first direction and a second direction of rotation results in displacement of the coupler pin 24 through an arc, the arc being tangent to the pin longitudinal axis B.

The pin box 10 may be installed to a towed vehicle, for example, as shown in FIGS. 7A and 7B. In such an embodiment, with the towed vehicle oriented for towing, that is, generally level with the ground, the coupler plate 24 also is generally level with the ground. Also, the coupler plate 24 and the coupler pin 26 are forward of and lower than the torsion axle axis A. In this orientation, with reference to FIG. 5, a line drawn through the torsion axle axis A and the portion of the coupler pin 24 that engages with the fifth wheel hitch of a tow vehicle may be at angle α with respect to level with the ground. In an embodiment, the angle α may be between 20 degrees and 70 degrees. In another embodiment, the angle α may be between 30 degrees and 60 degrees. In a further embodiment, the angle α may be between 40 degrees and 50 degrees. In yet another embodiment, the angle α may be about 45 degrees.

In any event, the pin box 10 may substantially absorb both bounce loads and chucking loads.

With the angle α greater than about 10 degrees, the pin box 10 may be able to absorb crash loads better than a conventional pin box because the torsion axle assembly 12 may be capable of absorbing and/or redirecting substantial energy resulting from a crash. For example, if a tow vehicle towing a towed vehicle were to hit an obstacle, for example, another vehicle or an immovable object, the tow vehicle would stop as a result of the impact. If the towed vehicle were equipped with a conventional pin box, the inertia of the towed vehicle would cause the towed vehicle to continue moving in the direction of the tow vehicle. Consequently, the tow vehicle could be crushed between the obstacle and the towed vehicle.

If the towed vehicle were equipped with the pin box 10 according to the present disclosure, however, the stopping or severe deceleration of the towed vehicle would cause the coupler plate 26 and pivot arms 22A, 22B to rotate in a first direction about the fifth wheel hitch and cause the inner bar 16 attached thereto to rotate in a second, opposite direction with respect to the outer tube 14. Consequently, the compressible members 18 would absorb some of the shock load resulting from the crash. Also, the front of the towed vehicle would rise with respect to the rear of the tow vehicle. The foregoing combination of events would dissipate crash energy and redirect the front of the towed vehicle upward with respect to the towed vehicle, offering a level of protection to the towed vehicle and its occupants.

### Second Embodiment

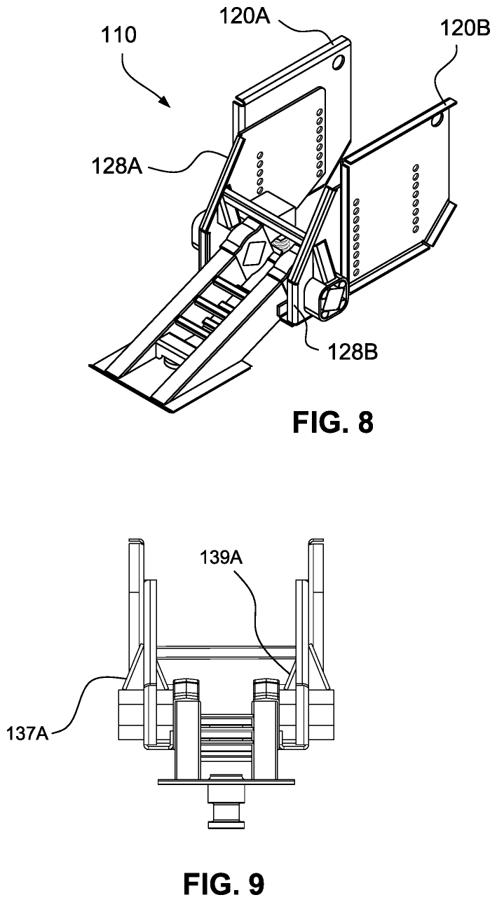

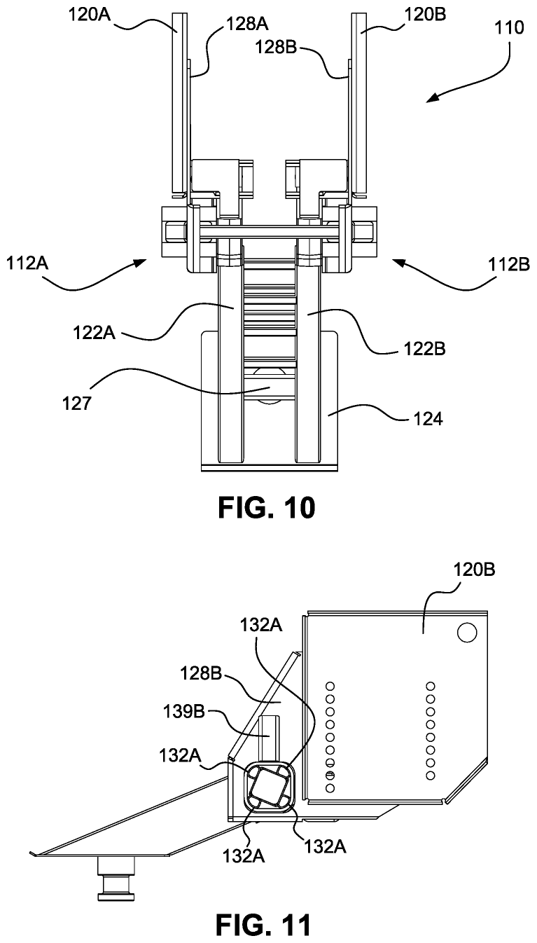

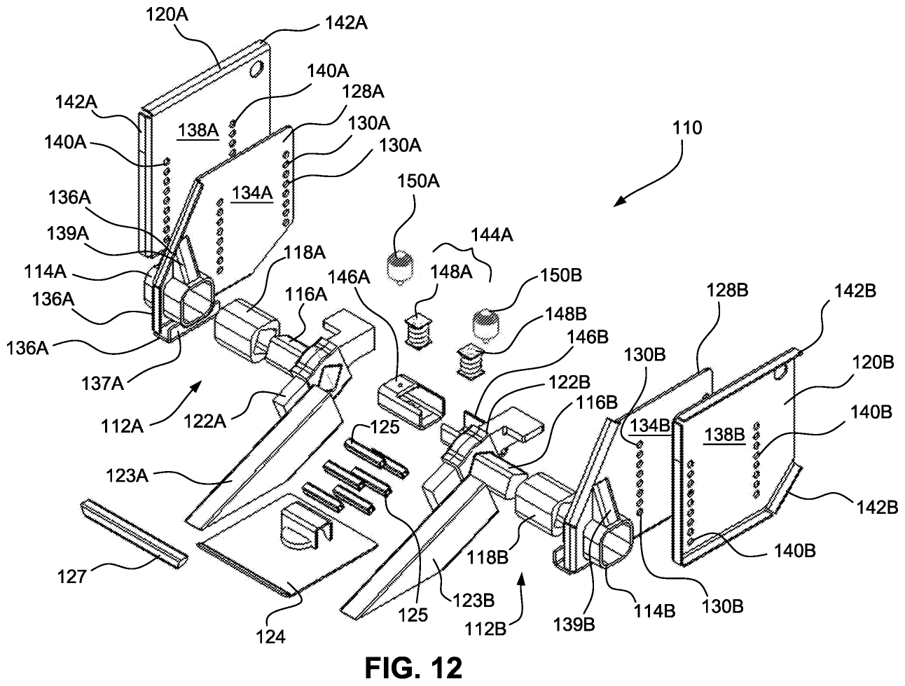

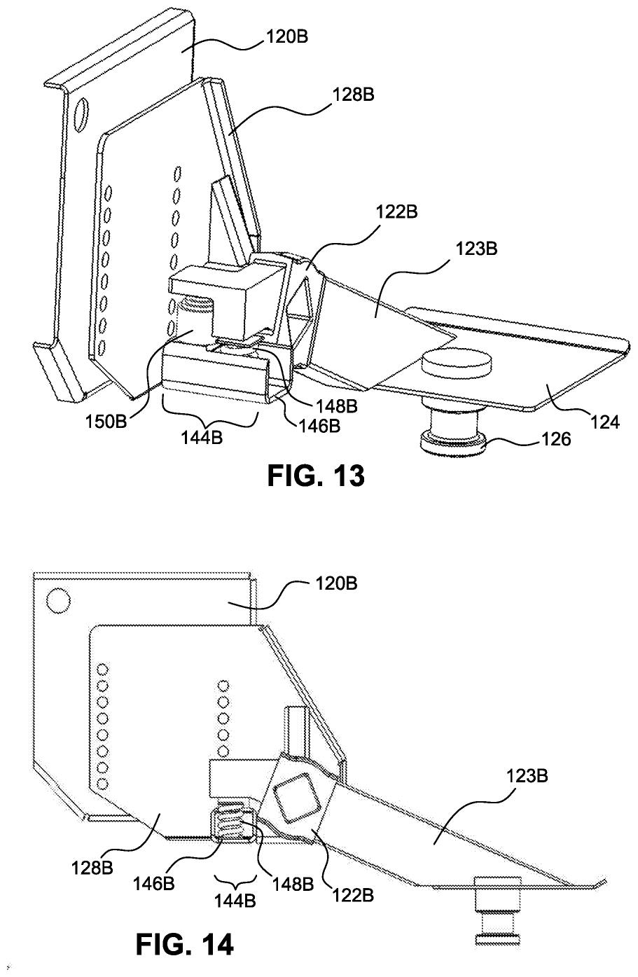

In another embodiment, as shown in FIGS. 8-15, a torsion axle pin box 110 includes a first torsion axle assembly 112A and a second torsion axle assembly 112B, each having a corresponding outer tube 114A, 114B and a corresponding inner bar 116A, 116B and a corresponding compressible member 118A, 118B therebetween. The torsion axle pin box 110 also includes a first end plate 128A connected to the outer tube 114A of the first torsion axle assembly 112A, a second end plate 128B connected to the outer tube 114B of the second torsion axle assembly 112B, a first pivot arm 122A connected to the inner bar 116A of the first torsion axle assembly 112A, a second pivot arm 122B connected to the inner bar 116B of the second torsion axle assembly 112B, a coupler plate 124 connected to the first and second pivot arms 112A, 122B, and a coupler pin 126 connected to the coupler plate 124.

The first and second torsion axle assemblies 112A, 112B may be identical to or mirror images of each other. As such, only the first torsion axle assembly 112A will be discussed in detail herein. Features of the second torsion axle assembly 112B having counterparts in the first torsion axle assembly 112A may be identified herein using like reference characters having the suffix “B” rather than “A.”

As set forth above, the first torsion axle assembly 112A includes an outer tube 114A, an inner bar 116A received within the outer tube, and a compressible member 118A disposed therebetween. The outer tube 114A is shown as an elongated, square tube having four side walls, a first (or inner) end, and a second (or outer) end. Each of the four side walls has an inner surface and an outer surface.

The inner bar 116A is shown as an elongated square bar received within the outer tube 114A, the inner bar 116A having a first end, a second end, and four side surfaces cooperating with each other to define four corners. The first end of the inner bar 116A may be proud of, flush with, or recessed from the corresponding end of the outer tube 114A. The second end of the inner tube 116A extends outwardly beyond the corresponding end of the outer tube 114A.

As shown, each of the four corners of the inner bar 116A is oriented between a corner of the outer tube and a midpoint of a corresponding one of the four side walls of the outer tube 114A. In other embodiments, each of the four corners of the inner bar 116A may be oriented anywhere between corresponding corners of the outer tube 114A. The inner bar 116A and the outer tube 114A thereby cooperate to define four triangular voids 132A between the walls of the outer tube and the side surfaces of the inner bar. Each of the four triangular voids 132A may be contiguous with one or two adjacent ones of the triangular voids.

As shown, the four triangular voids 132A are contiguous with each other, and the compressible member 118A is embodied as a single, monolithic block of resilient, compressible material substantially completely filling the space between the outer tube 114A and the inner bar 116A. In this embodiment, the compressible member 118A may be made by extrusion, by pouring of liquefied material into the space between the outer tube 114A and the inner bar 116A, or by another suitable process. In an embodiment, the outer surface of the compressible member 118A may be adhered to the inner surface of the outer tube 114A, and the inner surface of the compressible member 118A may be adhered to the outer surface of the inner bar 116A. In such an embodiment, the material of which the compressible member 118A is made may inherently adhere to the outer surface of the inner bar 116A. Alternatively, an adhesive could be added to such material, or applied to the outer surface of the inner bar 116A. The following table shows non-limiting examples of material properties suitable for the compressible member 118A.

| | Durometer Shore | | | |
|---|---|---|---|---|
| | 80 A | 90 A | 95 A | 75 D |
| 100% | 800 (5.5) | 1100 (7.6) | 1800 (12.4) | 5000 (34.5) |
| Modulus, | | | | |
| psi (Mpa) | | | | |
| 300% | 1500 (10.3) | 2200 (15.2) | 4300 (29.6) | N/A |
| Modulus, | | | | |
| psi (Mpa) | | | | |
| Tensile | 5000 (34.4) | 5500 (37.9) | 6500 (44.8) | 8000 (55.1) |
| Strength, | | | | |
| psi (Mpa) | | | | |
| Elongation % | 490 | 430 | 380 | 210 |
| Die C Tear, | 530 (92.8) | 700 (123) | 700 (123) | 120 (21.0) |
| pli (kN/m) | | | | |
| Bashore | 58 | 40 | 40 | 35 |
| Rebound, % | | | | |
| Compression | 25 | 36 | 36 | 55 |
| Set, Method | | | | |
| B, 22 hrs | | | | |
| @158° F. | | | | |
| Specific | 1.07 | 1.13 | 1.13 | 1.21 |
| Gravity | | | | |

In another embodiment, a plurality of resilient, compressible members 118A similar to the compressible members 18 of the torsion axle pin box 10 may be disposed between the outer tube 114A and the inner bar 116A in a manner similar to that in which the compressible members 18 are disposed between the outer tube 14 and the inner bar 16.

Each of the outer tube 114A and the inner bar 116A has a longitudinal axis. The longitudinal axes of the outer tube 114A and the inner bar 116A may be coincident or nearly coincident when the inner bar and the compressible members are received within the outer tube 114A as described above. The foregoing coincident or nearly coincident longitudinal axes of the outer tube 114A and the inner bar 116A may be referred herein as the longitudinal axis A of the first torsion axle assembly 112A. (The second torsion axle assembly 112B similarly defines a longitudinal axis coincident with the longitudinal axis A.)

As shown, the first end plate 128A is attached to the first outer tube 114A, for example, by welding. The first end plate 128A defines an opening having a shape complementary to the shape of, and configured to receive, the outer tube 114A so that the end plate may be welded to the outer surface of any or all of the walls of the outer tube 114A. As shown, the end plate 128A may be located near the midpoint of the outer tube 114A. The first end plate 128A may define a plurality of holes 130A configured to receive mechanical fasteners (not shown) that may be used to connect the first end plate to a first towed vehicle mounting plate 120A, as will be discussed further below. (The second end plate 128B similarly may define a plurality of holes 130B configured to receive mechanical fasteners (not shown) that may be used to connect the second end plate to a second towed vehicle mounting plate 120B.)

As shown, the first end plate 128A includes a web 134A. The web 134A may be hexagonal with parallel, opposed edges. One or more flanges 136A may extend from the web 134A, perpendicular thereto. A return 137A may extend from one or more of such flanges 136A. The return 137A may be welded to a corresponding outer wall of the first outer tube 114A. A gusset 139A may be welded to a first (or inner) surface of the web 134A and to a corresponding wall of the first outer tube 114A. A further gusset 139A may similarly be welded to a second (or outer) surface of the web 134A opposite the first surface of the web and to the corresponding wall of the first outer tube 114A.

The first pivot arm 122A is connected, proximate its midpoint, in fixed engagement to the second end of the first inner bar 116A. Similarly, the second pivot arm 122B is connected, proximate its midpoint, in fixed engagement to the second end of the second inner bar 116B.

A first pivot arm extension 123A is connected to, and extends forward of, a forward portion of the first pivot arm 122A. As shown, the first pivot arm extension 123A is an elongated member having a first end defining a recess, the recess receiving the forward portion of the first pivot arm 122A. A second pivot arm extension 123B is similarly connected to the second pivot arm 122B. In an embodiment, the first and second pivot arm extensions 123A, 123B could be integrally formed with the respective first and second pivot arms 122A, 122B.

The coupler plate 124 is connected, for example, by welding, to the first pivot arm extension 123A and the second pivot arm extension 123B proximate forward and lower bounds thereof. Also, one or more support tubes 125 are connected, for example, by welding, to the first pivot arm extension 123A and the second pivot arm extension 123B at one or more locations between the forward and lower bounds thereof and upper and rearward bounds thereof.

A first spring assembly 144A may be connected between the first end plate 128A and the first pivot arm 122A. More specifically, the first spring assembly 144A may include a first spring carrier 146A connected to an inner face of the web 134A, for example, by welding. The first spring assembly 144A may also include a first spring 148A, for example, a coil spring, connected to the first spring carrier 146A and configured for bearing engagement with and compression by a rearward portion of the first pivot arm 122A. A first bumper 150A, for example, a rubber or other flexible and resilient member, may be independently disposed between the first spring carrier 146A and the first pivot arm 122A. The first bumper 150A may be connected to either of the first spring carrier 144A and the first pivot arm 122A. A second spring assembly 144B may be similarly configured and similarly connected between the second end plate 128BA and the second pivot arm 122B.

The first towed vehicle mounting plate 120A and the second towed vehicle mounting plate 120B may be identical to or mirror images of each other. As such, only the first towed vehicle mounting plate 120A will be discussed in detail herein. Features of the second towed vehicle mounting plate 120B having counterparts in the first towed vehicle mounting plate 120A may be identified herein using like reference characters having the suffix “B” rather than “A.”

As shown, the first towed vehicle mounting plate 120A may include a web 138A defining a plurality of mounting holes 140A. The mounting holes 140A may be arranged in a manner complementary to the arrangement of the mounting holes 130A of the first end plate 128A. As such, ones of the mounting holes 140A of the first towed vehicle mounting plate 120A may overlie corresponding ones of the mounting holes 130A of the first end plate 128A in registration therewith when the first towed vehicle mounting plate is placed in abutment with the first end plate. One or more flanges 142A may extend from the web 138A, perpendicular thereto. In an embodiment, the first towed vehicle mounting plate 120A could be omitted, and the first end plate 128A could function as both the first end plate and as the first towed vehicle mounting plate.

The angular relationship between the coupler plate 124, the first and second pivot arms 122A, 122B, and the first and second pivot arm extensions 123A, 123B of the torsion axle pin box 110 may be similar to the angular relationship between the coupler plate 24 and the first and second pivot arms 22A, 22B of the torsion axle pin box 10. The operation of the torsion axle pin box 110 is similar to the operation of the torsion axle pin box 10. If the torsion axle pin box 110 is fitted with the spring assemblies 144A, 144B, the spring assemblies may serve to limit the angular excursion of the pivot arms 122A, 122B with respect to the outer tubes 114A, 114B. Also, the spring assemblies 144A, 144B may serve to further dampen rotation of the inner tubes 116A, 116B of the first and second torsion axle assemblies 112A, 112B with respect to the outer tubes 114A, 114B thereof.

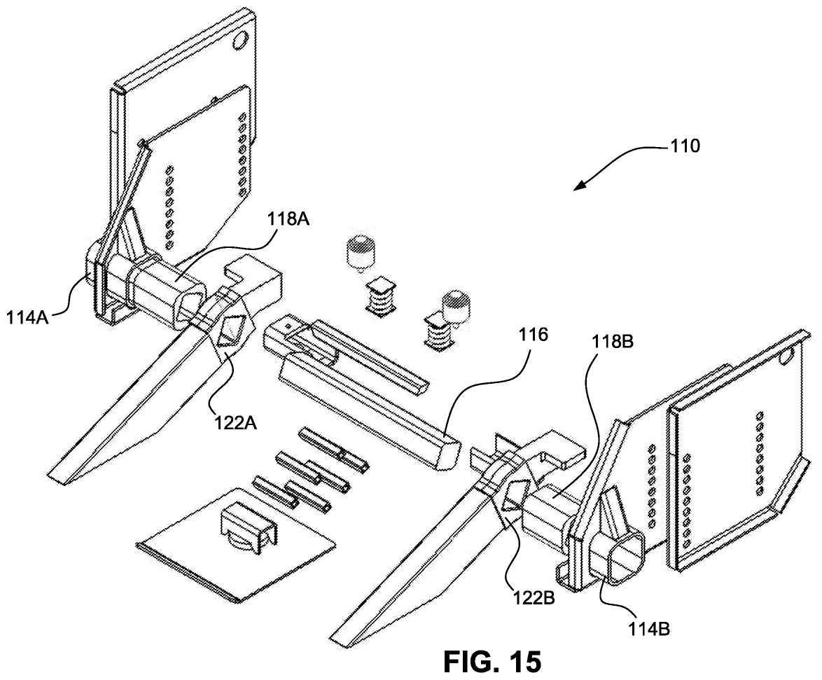

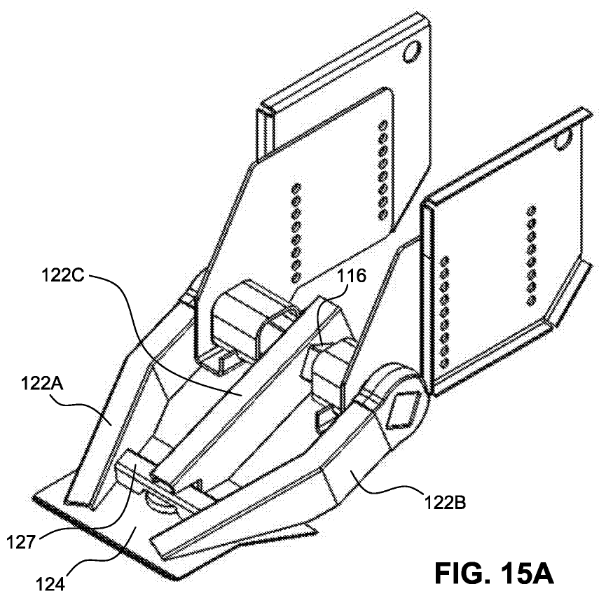

FIG. 15 shows a variation of the torsion axle pin box 110 in which a single inner bar 116 replaces the first and second inner bars 116A, 116B. In this variation, a first end of the inner bar 116 extends through the first pivot arm 122A into the first compressible member 118A (which is received within the first outer tube 114A), and a second end of the inner bar 116 extends through the second pivot arm 122B into the second compressible member 118B (which is received within the second outer tube 114B).

FIG. 15A shows a further variation of the torsion axle pin box 110 with a single inner bar 116, where a third pivot arm 122C is connected between the single inner bar 116 and the coupler plate 124 via a bridge 127 connected between the first pivot arm 122A and the second pivot arm 122B. In this embodiment, the third pivot arm 122C defines an aperture receiving and closely conforming to the outer profile or cross-section of the inner bar 116.

### Third Embodiment

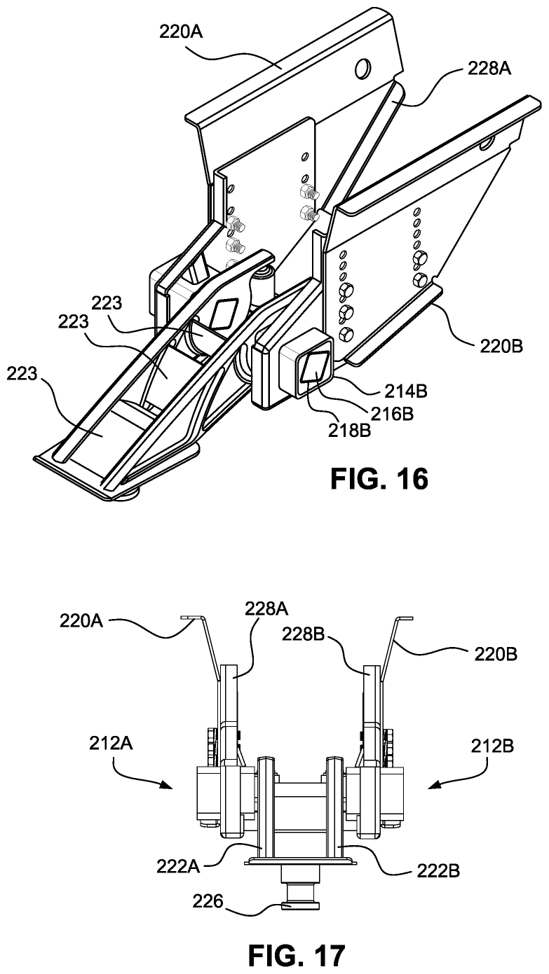

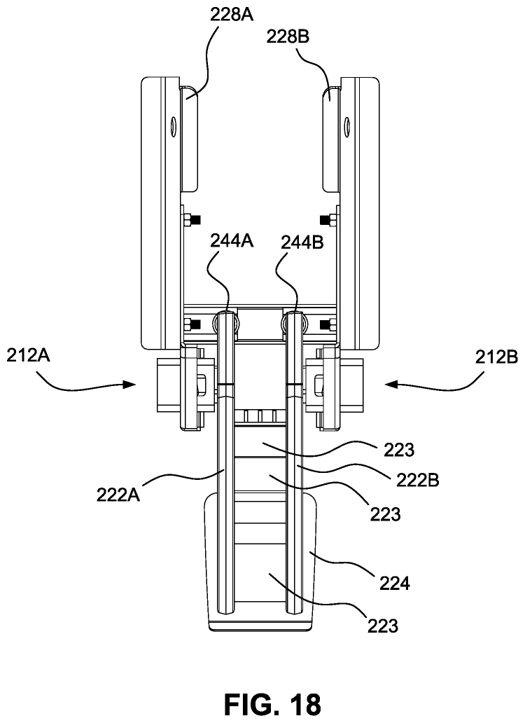

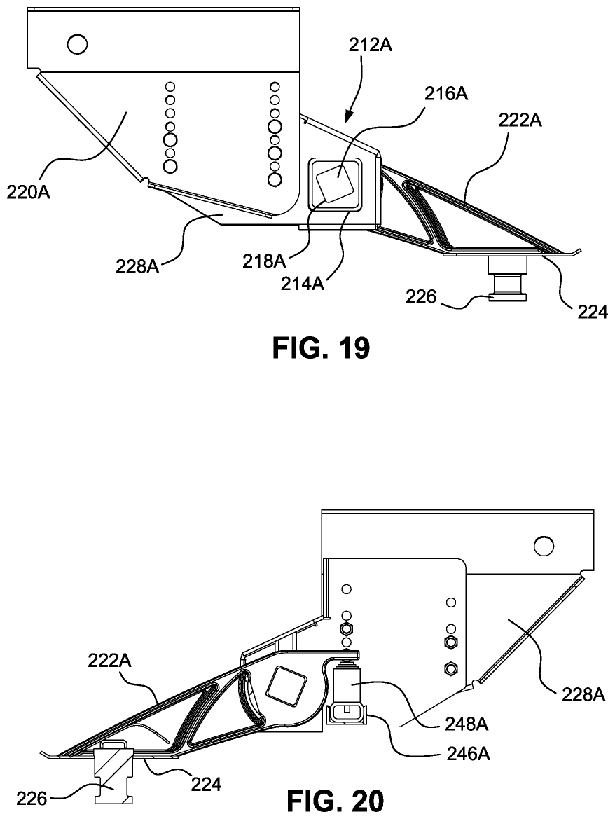

In yet another embodiment, as shown in FIGS. 16-20, a torsion axle pin box 210 includes a first torsion axle assembly 212A and a second torsion axle assembly 212B, each having an outer tube 214A, 214B, an inner bar 216A, 216B and a compressible member 218A, 218B therebetween. The torsion axle pin box 210 also includes a first towed vehicle mounting bracket 220A connected to the outer tube 214A of the first torsion axle assembly 212A, a second towed vehicle mounting bracket 220B connected to the outer tube 214B of the second torsion axle assembly 212B, a first pivot arm 222A connected to the inner bar 216A of the first torsion axle assembly 212A, a second pivot arm 222B connected to the inner bar 216B of the second torsion axle assembly 212B, a coupler plate 224 connected to the first and second pivot arms, and a coupler pin 226 connected to the coupler plate.

The first and second torsion axle assemblies 212A, 212B are substantially similar to the first and second first torsion axle assemblies 112A, 112B of the torsion axle pin box 110. First and second end plates 228A, 228B that are substantially similar to the first and second end plates 128A, 128B of the torsion axle pin box 110 and are connected to the first and second torsion axle assemblies 212A, 212B in a manner substantially similar to that in which the first and second end plates 128A, 128B of the torsion axle pin box 110 are connected to the first and second first torsion axle assemblies 112A, 112B thereof. As such, the foregoing components and their interconnection will not be discussed in further detail unless necessary for understanding of the torsion axle pin box 210.

The first and second pivot arms 222A, 222B are substantially similar to the first and second pivot arms 122A, 122B of the torsion axle pin box 110, integrally formed with the first and second pivot arm extensions 123A, 123B of the torsion axle pin box 110. The first and second pivot arms 222A, 222B are connected to the inner tubes 216A, 216B of the first and second torsion axle assemblies 212A, 212B in a manner substantially similar to that in which the first and second end pivot arms 122A, 122B of the torsion axle pin box 110 are connected to the inner tubes 116A, 116B of the first and second first torsion axle assemblies 112A, 112B thereof. As such, the foregoing components and their interconnection will not be discussed in further detail unless necessary for understanding of the torsion axle pin box 210.

The coupler plate 224 and coupler pin 226 are substantially similar to the coupler plate 124 and the coupler pin 126 of the torsion axle pin box 110. As such, the foregoing components will not be discussed in further detail unless necessary for understanding of the torsion axle pin box 210. Whereas the torsion axle pin box 110 includes a plurality of support tubes 125 interconnecting the first and second pivot arm extensions 123A, 123B, the torsion axle pin box 210 includes a plurality of support plates or gussets 223 interconnecting the first and second lever arms 222A, 222B.

The torsion axle pin box 210 may include first and second spring assemblies 244A, 244B substantially similar to the first and second spring assemblies 144A, 144B of the torsion axle pin box 110.

The first and second towed vehicle mounting plates 220A, 220B are substantially similar to the first and second towed vehicle mounting plates 120A, 120B of the torsion axle pin box 110, except that upper portions of the first and second towed vehicle mounting plates 220A, 220B are flared outwardly, away from each other. The first and second towed vehicle mounting plates 220A, 220B are connected to the first and second end plates 228A, 228B in a manner substantially similar to that in which the first and second towed vehicle mounting plates 120A, 120B of the torsion axle pin box 110 are connected to the first and second end plates 128A, 128B thereof. As such, the foregoing components and their interconnection will not be discussed in further detail unless necessary for understanding of the torsion axle pin box 210.

The angular relationship between the coupler plate 224 and the first and second pivot arms 222A, 222B of the torsion axle pin box 110 may be similar to the angular relationship between the coupler plate 24 and the first and second pivot arms 22A, 22B of the torsion axle pin box 10. The operation of the torsion axle pin box 210 is similar to the operation of the torsion axle pin box 10. If the torsion axle pin box 210 is fitted with the spring assemblies 244A, 244B, the spring assemblies may serve to limit the angular excursion of the pivot arms 222A, 222B with respect to the outer tubes 214A, 214B.

The present disclosure shows and describes certain illustrative embodiments of a torsional axle pin box. Features disclosed in connection with a given embodiment may be used in connection with any other embodiment to the greatest extent possible.

### Fourth Embodiment

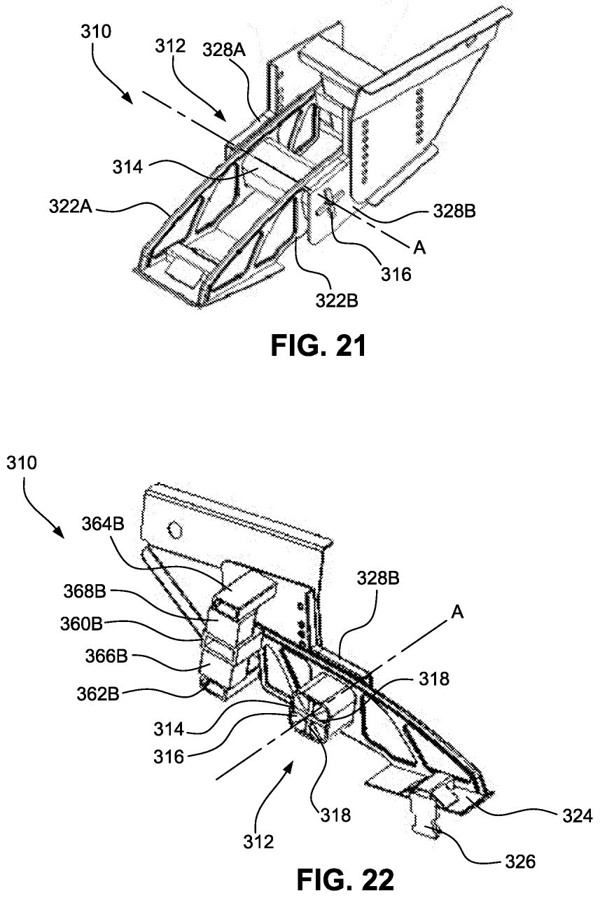

In still another embodiment, as shown in FIGS. 21 and 22, a torsion axle pin box 310 includes a torsion axle assembly 312 having an outer tube 314, an inner bar 316 received within the outer tube, and a plurality of compressible members 318 disposed between the outer tube 314 and the inner bar 316. The outer tube 314 and the inner bar 316 cooperate to define a pivot axis A. A coupler plate 324 carrying a coupler pin 326 is connected between the first and second pivot arms 322A, 322B proximate first ends thereof.

The outer tube 314 is similar to the outer tube 14 of the first embodiment, having a generally square cross-section defining four interconnected walls. The inner bar 316 has a cross-shaped profile. As such, the juxtaposition of the inner bar 316 within the outer tube 314 defines four voids. At least one compressible member 318 is disposed within each of the four voids.

The inner bar 316 may be disposed within the outer tube 314 so the free edges of the inner bar 316 within the outer tube 314 lie adjacent the walls of the outer tube 314 proximate the midpoints thereof. As such, each of the voids defined by the juxtaposition of the inner bar 316 within the outer tube 314 is generally square.

The outer tube 314 is connected to each of first and second pivot arms 322A, 322B, for example, by welding. In an embodiment, respective end portions of the outer tube 314 may be received within correspondingly-shaped and sized apertures defined by the first and second pivot arms 322A, 322B.

The inner bar 316 is connected to each of first and second end plates 328A, 328B. In an embodiment, respective end portions of the inner bar 316 may be received within correspondingly-shaped and sized apertures defined by the first and second end plates 328A, 328B.

As best shown in FIG. 22, a bumper engagement member 360B may be connected to the second pivot arm 322B proximate a second end of the second pivot arm opposite the pivot axis A from the coupler plate 324. Also, a first (or lower) bump stop 362B may be connected to the second end plate 328B on a first (or lower) side of the bumper engagement member 360B, and a second (or upper) bump stop 364B may be connected to the second end plate 328B on a second (or upper) side of the bumper engagement member 360B. A first bumper 366B may be resiliently and compressibly disposed between the bumper engagement member 360B and the first bump stop 362B, and a second bumper 368B may be resiliently and compressibly disposed between the bumper engagement member and the second bump stop 364B. A similar arrangement of bumper engagement member, bump stops, and bumpers may be provided in connection with first pivot arm 322A and the first end plate 328A.

The torsion axle pin box 310 may in other respects be similar to any or all of the torsion axle pin boxes 10, 110, 210.

Various illustrative and non-limiting embodiments of a torsion axle pin box are shown and described herein. Features shown connection with any embodiment may be incorporated into any other embodiment to the greatest extent possible. Terms of orientation, for example, upper, lower, left, right, forward, rearward, and the like as may be used herein should be construed in a relative, rather than absolute, sense, unless contact clearly dictates otherwise.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A fifth wheel pin box comprising:
an elongated torsion axle comprising:
an elongated outer tube;
an elongated inner bar disposed within the outer tube, the inner bar having a longitudinal axis; and
a plurality of resilient, compressible members disposed between the inner bar and the outer tube;
wherein the plurality of resilient, compressible members bias the inner bar to a first orientation with respect to the outer tube;
a towed vehicle mounting bracket connected to the outer tube;
a plurality of pivot arms having respective first ends connected to the elongated inner bar in keyed engagement therewith;
a coupler plate connected to respective second ends of the plurality of pivot arms; and
a coupler pin extending from the coupler plate, the coupler pin configured for selective engagement with a fifth wheel hitch, the coupler pin having a longitudinal axis;
wherein rotation of the elongated inner bar about the inner bar longitudinal axis in either of a first direction and a second direction from the first orientation compresses or further compresses the plurality of resilient, compressible members.

2. The pin box of claim 1, wherein rotation of the elongated inner bar about the inner bar longitudinal axis in either of a first direction and a second direction from the first orientation results in displacement of the pin through an arc, the arc being tangent to the pin longitudinal axis.

3. The pin box of claim 1, wherein ones of the plurality of the resilient, compressible members have a first hardness and other ones of the resilient, compressible members have a second hardness greater than the first hardness.

4. The pin box of claim 1, further comprising a damper connected between the coupler plate and at least one of the towed vehicle mounting bracket and the torsion axle.

5. The pin box of claim 1, the torsion axle further comprising a first end plate connected to the outer tube proximate a first end thereof and a second end plate connected to the outer tube proximate a second end thereof.

6. A torsion axle pin box comprising:
a torsion axle assembly having an outer tube, an inner bar, and a compressible member disposed between the outer tube and the inner bar;
a towed vehicle mounting bracket connected to the outer tube;
first and second pivot arms connected to the inner bar;
a coupler plate connected between the first and second pivot arms; and
a coupler pin connected to the coupler plate,
wherein the outer tube and the towed vehicle mounting bracket are pivotable relative to the inner bar and the first and second pivot arms.

7. The torsion axle pin box of claim 6, wherein a cross-section of the outer tube is non-circular.

8. The torsion axle pin box of claim 7, further comprising first and second end plates connected at respective ends of the outer tube, the first and second end plates having openings therein shaped corresponding to the cross-section of the outer tube, wherein the first and second end plates are secured to the towed vehicle mounting bracket.

9. The torsion axle pin box of claim 6, wherein the outer tube comprises an elongated square tube with four side walls, and wherein the inner bar comprises an elongated square bar, wherein corners of the inner bar are positioned at about a midpoint of respective ones of each of the four side walls, thereby defining four essentially triangular voids, and wherein a plurality of compressible members are disposed in the triangular voids.

10. The torsion axle pin box of claim 9, wherein at least one of the compressible members comprises a first hardness, and wherein at least another of the compressible members comprises a second hardness, different from the first hardness.

11. The torsion axle pin box of claim 6, further comprising an intermediate tube disposed between the outer tube and the inner bar.

12. The torsion axle pin box of claim 11, wherein the outer tube comprises an elongated square tube with four side walls, wherein the intermediate tube comprises an elongated square tube with four side walls, and wherein the inner bar comprises an elongated square bar, wherein corners of the intermediate tube are positioned at about a midpoint of respective ones of each of the four side walls of the outer tube, thereby defining a first four essentially triangular voids, and wherein corners of the inner bar are positioned at about a midpoint of respective ones of each of the four side walls of the intermediate tube, thereby defining a second four essential triangular voids, and wherein a plurality of compressible members are disposed in the first and second triangular voids.

13. The torsion axle pin box of claim 6, wherein the first and second pivot arms are connected to opposite ends of the inner bar in keyed engagement.

14. The torsion axle pin box of claim 13, wherein a longitudinal axis of the torsion axle assembly is perpendicular to and spaced from a longitudinal axis of the coupler pin, and wherein a line through the torsion axle axis and the coupler pin is angled greater than 10 degrees relative to ground.

15. The torsion axle pin box of claim 14, wherein the line through the torsion axle axis and the coupler pin is angled between 20-70 degrees.

16. The torsion axle pin box of claim 6, wherein the compressible member comprises a single monolithic block of resilient compressible material filling a space between the outer tube and the inner bar.

17. The torsion axle pin box of claim 6, further comprising:
first and second end plates connected at respective ends of the outer tube; and
a spring assembly connected between each of the first and second end plates and the first and second pivot arms, respectively.

18. The torsion axle pin box of claim 6, further comprising a plurality of support tubes or gusset plates interconnecting the first and second pivot arms.

19. The torsion axle pin box of claim 6, wherein the inner bar comprises a cross-shaped profile defining four voids between the inner bar and the outer tube.

20. The torsion axle pin box of claim 19, wherein at least one of the compressible member is disposed within each of the four voids.
